(19) United States
(12) Patent Application Publication
(10) Pub. No.: US 2025/0287169 A1
(43) Pub. Date: Sep. 11, 2025

(54) APPARATUS AND METHOD FOR PERCEPTION-BASED CLUSTERING OF OBJECT-BASED AUDIO SCENES

(71) Applicant: Fraunhofer-Gesellschaft zur Förderung der angewandten Forschung e.V., München (DE)

(72) Inventors: Sascha DICK, Erlangen (DE); Jürgen HERRE, Erlangen (DE)

(73) Assignee: Fraunhofer-Gesellschaft zur Förderung der angewandten Forschung e.V., München (DE)

(21) Appl. No.: 19/093,275

(22) Filed: Mar. 28, 2025

Related U.S. Application Data
(63) Continuation of application No. PCT/EP2023/076707, filed on Sep. 27, 2023.

(30) Foreign Application Priority Data
Sep. 29, 2022 (EP) 22198817.3

(51) Int. Cl. H04S 7/00; G10L 19/008; H04S 3/00

(52) U.S. Cl. CPC H04S 7/302; G10L 19/008; H04S 3/008; H04S 2400/01; H04S 2400/11

(57) ABSTRACT

An apparatus according to an embodiment is provided The apparatus comprises an input interface for receiving information on three or more audio objects. Moreover, the apparatus comprises a cluster generator for generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster. The cluster generator is configured to generate the two or more audio object clusters depending on a perception-based model.

### CROSS-REFERENCE TO RELATED APPLICATIONS

This application is a continuation of copending International Application No. PCT/EP2023/076707, filed Sep. 27, 2023, which is incorporated herein by reference in its entirety, and additionally claims priority from European Application No. EP 22198817.3, filed Sep. 29, 2022, which is also incorporated herein by reference in its entirety.

The present invention relates to an apparatus and a method for perception-based clustering of object-based audio scenes.

### BACKGROUND OF THE INVENTION

Modern audio reproduction systems enable an immersive, three-dimensional (3D) sound experience.

One common format for 3D sound reproduction is channel-based audio, where individual channels associated to defined loudspeaker positions are produced via multi-microphone recordings or studio-based production. Another common format for 3D sound reproduction is object-based audio, which utilizes so-called audio objects, which are placed in the listening room by the producer and are converted to loudspeaker or headphone signals by a rendering system for playback. Object-based audio allows a high flexibility when it comes to design and reproduction of sound scenes. Note that channel-based audio may be considered to be a special case of object-based audio, where sound sources (=objects) are positioned in fixed positions that correspond to the defined loudspeaker positions.

To increase efficiency of transmission and storage of object-based immersive sound scenes, as well as to reduce computational requirements for real-time rendering, it is beneficial or even needed to reduce or limit the number of audio objects. This is achieved by identifying groups or clusters of neighboring audio objects and combining them into a lower number of sound sources. This process is called object clustering or object consolidation.

It has been shown in literature, that the localization accuracy of human hearing is limited and dependent on the sound source position (e.g. horizontal localization is more accurate than vertical localization), and that auditory masking effects can be observed between spatially distributed sound sources. By exploiting those limitations of localization accuracy in human hearing and auditory masking effects for object clustering, a significant reduction in the number of audio objects can be achieved while maintaining high perceptual quality.

In order to reduce the number of audio objects while retaining a high perceptual quality, methods and algorithms have been developed to perform clustering of object-based audio based on the perceptual properties of audio scenes, relative to a listener.

In the state of the art, auditory masking and localization models are known.

Moreover, directional loudness maps (DLM) have been presented in the state of the art. Examples are,
C. Avendano, “Frequency-domain source identification and manipulation in stereo mixes for enhancement, suppression and re-panning applications,” in 2003 IEEE Workshop on Applications of Signal Processing to Audio, and
P. Delgado, J. Herre, “Objective Assessment of Spatial Audio Quality using Directional Loudness Maps”, in Proc. 2019 IEEE ICASSP

Furthermore, object clustering algorithms have been presented in the state of the art, for example,
J. Herder. “Optimization of Sound Spatialization Resource Management through Clustering”, The Journal of Three Dimensional Images, 1999,
Nicolas Tsingos, Emmanuel Gallo, George Drettakis: “Perceptual Audio Rendering of Complex Virtual Environments”, SIGGRAPH, 2004,
Breebaart, Jeroen; Cengarle, Giulio; Lu, Lie; Mateos, Toni; Purnhagen, Heiko; Tsingos, Nicolas: “Spatial Coding of Complex Object-Based Program Material”; JAES Volume 67 Issue 7/8 pp. 486-497; July 2019

Moreover, in the state of the art, GMM Expectation-Maximization Algorithms (EM-Algorithms), have been presented.

The state of the art algorithms for clustering of object-based audio consider the spatial properties of the audio objects relative to each other. However, they do not consider the perceptual properties relative to the listener, and thus do not consider the location dependency in spatial localization accuracy in human hearing.

### SUMMARY

According to an embodiment, an apparatus may have: an input interface for receiving information on three or more audio objects, and a cluster generator for generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the cluster generator is configured to generate the two or more audio object clusters depending on a perception-based model.

According to another embodiment, a system may have: an inventive apparatus, wherein the apparatus further comprises an encoding unit for generating encoded information which encodes information on the two or more audio object clusters, and a decoding unit for decoding the encoded information to obtain the information on the two or more audio object clusters, and a signal generator for generating two or more audio output signals depending on the information on the two or more audio object clusters.

According to another embodiment, a decoder may have: a decoding unit for decoding encoded information to obtain information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model, and a signal generator for generating two or more audio output signals depending on the information on the two or more audio object clusters.

According to another embodiment, a method may have the steps of: receiving information on three or more audio objects, and generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein generating the two or more audio object clusters is conducted depending on a perception-based model.

According to another embodiment, a method may have the steps of: decoding encoded information to obtain information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model, and generating two or more audio output signals depending on the information on the two or more audio object clusters.

Another embodiment may have a non-transitory digital storage medium having a computer program stored thereon to perform any of the inventive methods when said computer program is run by a computer.

An apparatus according to an embodiment is provided. The apparatus comprises an input interface for receiving information on three or more audio objects. Moreover, the apparatus comprises a cluster generator for generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster. The cluster generator is configured to generate the two or more audio object clusters depending on a perception-based model.

Moreover, a decoder is provided. The decoder comprises a decoding unit for decoding encoded information to obtain information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model. Moreover, the decoder comprises a signal generator for generating two or more audio output signals depending on the information on the two or more audio object clusters.

Furthermore, a method according to an embodiment is provided. The method comprises:
Receiving information on three or more audio objects. And:
Generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster. Generating the two or more audio object clusters is conducted depending on a perception-based model.

Moreover, a method according to another embodiment is provided. The method comprises:
Decoding encoded information to obtain information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model. And:
Generating two or more audio output signals depending on the information on the two or more audio object clusters.

Moreover, computer programs are provided, wherein each of the computer programs is configured to implement one of the above-described methods when being executed on a computer or signal processor.

According to an embodiment, a perception-based clustering algorithm groups audio objects in an audio scene into clusters, and combines the original objects into fewer output objects, e.g., by combining their signals and, e.g., by selecting a common centroid position as output object position, based on perceptual model criteria. Based on the target use-case, the goal can be to achieve a given (maximum) number of output clusters, or to reduce the number of objects in a scene, without introducing perceivable differences beyond a given limit. This can be achieved using different embodiments presented in the following.

Some embodiments relate to a clustering of audio objects

According to an embodiment, Gaussian mixture model (GMM) based clustering is provided.

In this generative clustering approach, a 3D Directional Loudness Map (3D-DLM) may, e.g., be calculated for the entire sound scene, to represent the overall spatial properties of the scene. A GMM is fitted to approximate the original DLM with a given number of components to represent the corresponding number of clusters. Thus, the algorithm aims to recreate the overall spatial properties of the sound scene rather than considering the individual object properties. This approach is especially beneficial if dense sound scene consisting of a high number of objects needs to be represented by only a few cluster positions, e.g. for low-complexity/low-bitrate applications.

In an embodiment, hierarchical clustering is provided. In this “agglomerative” clustering approach, objects are iteratively combined, e.g., based on a perceptual distance metric until a target number of clusters is reached and/or a given limit of the distance metric is reached (e.g. all imperceptible differences are eliminated). This approach is computationally efficient and offers the flexibility to be configured for constant quality or constant rate applications. Furthermore, it scales well up to transparency, e.g. in cases when the number of active audio objects is below the allowed maximum number of clusters.

According to an embodiment, JND (just noticeable difference) based clustering is provided. This can be considered a simplified special case of the hierarchical clustering approach: When objects are so close that their positions cannot be distinguished, they may, e.g., be combined to reduce redundancy without perceivable differences in the overall sound scene.

Therefore, the JND based clustering approach determines groups of objects which are all mutually within the JND for a perceptual distance metric and combines them into clusters. This approach involves low computational complexity and results in a variable number of output clusters at (near-) transparent perceptual quality.

Enhancements are provided in further embodiments.

Additionally, several optimizations regarding temporal stability and the resulting cluster output positions have been developed:

For example, according to an embodiment, temporal stabilization is provided. Since clustering algorithms typically operate on a frame-by-frame basis, several measures may, e.g., be taken to improve temporal stability of the cluster algorithm's results: The membership of objects to clusters may, e.g., be stabilized by a penalty factor for re-assignment of objects to clusters in the perceptual distance metrics. For DLM based approaches the DLM may, e.g., be temporally smoothed for improved temporal stability. Permutations in the cluster index order may, e.g., be identified and optimized in order to improve stabilize the output signals and positional metadata.

And/or, for example, in an embodiment, centroid position optimization is provided. Clustering algorithms typically result in cluster centroid positions and object cluster memberships. However, the output cluster position may, e.g., further be optimized using perceptual criteria under consideration of the target reproduction scenario.

According to some embodiments, signal mixing and processing concepts are provided. Based on the results of the presented clustering algorithms, the input audio objects' signals may, e.g., be mixed and combined to obtain the output cluster signals. The signal processing in this mixing stage may, e.g., also be perceptually optimized by several aspects, such as crossfading to avoid signal discontinuities, and/or handling of correlation between signals, and/or consideration of distance-based gain differences, and/or equalization to compensate for changes in spectral localization cues.

### BRIEF DESCRIPTION OF THE DRAWINGS

Embodiments of the present invention will be detailed subsequently referring to the appended drawings, in which:

FIG. 1 illustrates an apparatus according to an embodiment.

FIG. 2 illustrates a decoder according to an embodiment.

FIG. 3 illustrates a system according to an embodiment.

FIG. 4 illustrates a one-dimensional example, in which a directional loudness map generated by ten sound sources is approximated by a Gaussian mixture model with only two components.

FIG. 5 illustrates three different distance model levels of JND based clustering according to embodiments

FIG. 6A-FIG. 6G illustrate a small-scale example for a Level 2 JND based clustering algorithm according to an embodiment.

FIG. 7 illustrates a cluster index permutation according to an embodiment due to slight changes in the scene.

FIG. 8 illustrates cluster assignment permutation and optimization according to an embodiment.

FIG. 9A-FIG. 9B illustrate a centroid projection in a unit sphere in the horizontal plane and a centroid projection in a perceptual coordinate system in the horizontal plane.

FIG. 10 illustrates a centroid to cones of confusion projection in a lateral plane according to an embodiment.

FIG. 11 illustrates a height preserving centroid projection to cones of confusion in a lateral plane according to an embodiment.

### DETAILED DESCRIPTION OF THE INVENTION

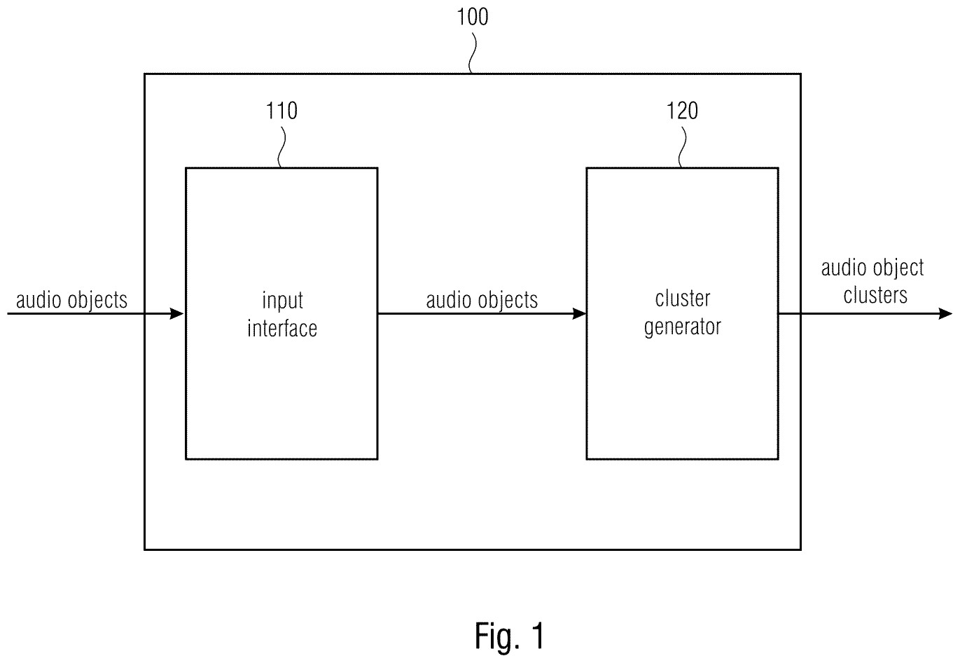

FIG. 1 illustrates an apparatus 100 according to an embodiment.

The apparatus 100 comprises an input interface 110 for receiving information on three or more audio objects.

Moreover, the apparatus 100 comprises a cluster generator 120 for generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster. The cluster generator 120 is configured to generate the two or more audio object clusters depending on a perception-based model.

According to an embodiment, the cluster generator 120 may, e.g., be configured to generate the two or more audio object clusters depending on a perception-based model by generating the two or more audio object clusters depending on at least one of a perceptual distance metric, a directional loudness map, a perceptual coordinate system, and a spatial masking model.

In an embodiment, the cluster generator 120 may, e.g., be configured to generate the two or more audio object clusters depending on the perceptual distance metric by determining for a pair of two audio objects of the three or more audio objects, whether said two audio objects have a perceptual distance according to the perceptual distance metric that is smaller than or equal to a threshold value, and by associating said two audio objects to a same one of the two or more audio object clusters, if said perceptual distance is smaller than or equal to said threshold value.

According to an embodiment, the cluster generator 120 may, e.g., be configured to generate the two or more audio object clusters depending on the perceptual distance metric by iteratively associating two perceptually closest audio objects among the three or more audio objects according to the perceptual distance metric until a predefined target number of audio object clusters has been reached or until a predefined maximum perceptual distance according to the perceptual distance metric is exceeded.

In an embodiment, the cluster generator 120 may, e.g., be configured to generate the two or more audio object clusters depending on a three-dimensional directional loudness map.

According to an embodiment, the cluster generator 120 may, e.g., be configured to generate the two or more audio object clusters by employing a Gaussian mixture model. Moreover, the cluster generator 120 may, e.g., be configured to determine two or more audio object clusters by determining components of the Gaussian mixture model such that the three-dimensional directional loudness map is approximated.

In an embodiment, the cluster generator 120 may, e.g., be configured to generate the two or more audio object clusters by employing a Gaussian mixture model. Furthermore, the cluster generator 120 may, e.g., be configured to determine two or more audio object clusters by employing an expectation-maximization algorithm for fitting weighted data points on an arbitrary grid of the Gaussian mixture model.

According to an embodiment, the cluster generator 120 may, e.g., be configured to conduct a perceptual optimization of a centroid position resulting from the clustering.

In an embodiment, the cluster generator 120 may, e.g., be configured to conduct an optimization of a cluster assignment and centroid position depending on a spectral matching for the two or more audio object clusters.

According to an embodiment, the cluster generator 120 may, e.g., be configured to generate the two or more audio object clusters as a first plurality of audio object clusters by creating associations of each of the three or more audio objects with at least one of the two or more audio object clusters. Moreover, the cluster generator 120 may, e.g., be configured to generate a second plurality of two or more audio object clusters, such that at least one audio object of the three or more audio objects is associated with a different audio object cluster of the second plurality of audio object clusters compared to the audio object cluster of the first plurality of audio object clusters, with which said at least one audio objects was associated.

In an embodiment, the cluster generator 120 may, e.g., be configured to generate the second plurality of two or more audio object clusters depending on a temporal smoothing and/or depending on one or more penalty factors in the perceptual distance metrics.

According to an embodiment, the cluster generator 120 may, e.g., be configured to generate the second plurality of two or more audio object clusters by conducting an optimization of cluster assignment permutations depending on an energy distribution of the three or more audio objects.

In an embodiment, the cluster generator 120 may, e.g., be configured to generate the second plurality of two or more audio object clusters by conducting a stabilization of resulting cluster centroid positions via hysteresis.

According to an embodiment, the cluster generator 120 may, e.g., be configured to generate the second plurality of two or more audio object clusters by conducting a perceptual optimization of a centroid position resulting from the clustering to generate the first plurality of two or more audio object clusters.

In an embodiment, the cluster generator 120 may, e.g., be configured to generate the second plurality of two or more audio object clusters by conducting an optimization of a cluster assignment and centroid position depending on a spectral matching for the first plurality of audio object clusters.

According to an embodiment, cluster generator 120 may, e.g., be configured, for each audio object cluster with which at least two of the three or more audio objects are associated, to conduct signal processing by combining the audio object signal of each audio object being associated with said audio object cluster.

In an embodiment, the cluster generator 120 may, e.g., be configured to conduct at least one of the following:
a crossfading to prevent signal discontinuities on object to cluster membership reassignments,
consideration of signal correlations to achieve energy preservation,
an adjustment of a distance-based gain,
equalization to compensate perceptual differences due to spectral cues.

According to an embodiment, the cluster generator 120 may, e.g., be configured to generate the two or more audio object clusters depending on a real position or an assumed position of a listener.

In an embodiment, the cluster generator 120 may, e.g., be configured to determine one or more properties of each audio object cluster of the two or more audio object clusters depending on one or more properties of those of the three or more audio objects which are associated with said audio object cluster, wherein said one or more properties comprise at least one of:
an audio signal being associated with said audio object cluster,
a position being associated with said audio object cluster.

According to an embodiment, the apparatus 100 may, e.g., further comprise an encoding unit for generating encoded information which encodes information on the two or more audio object clusters.

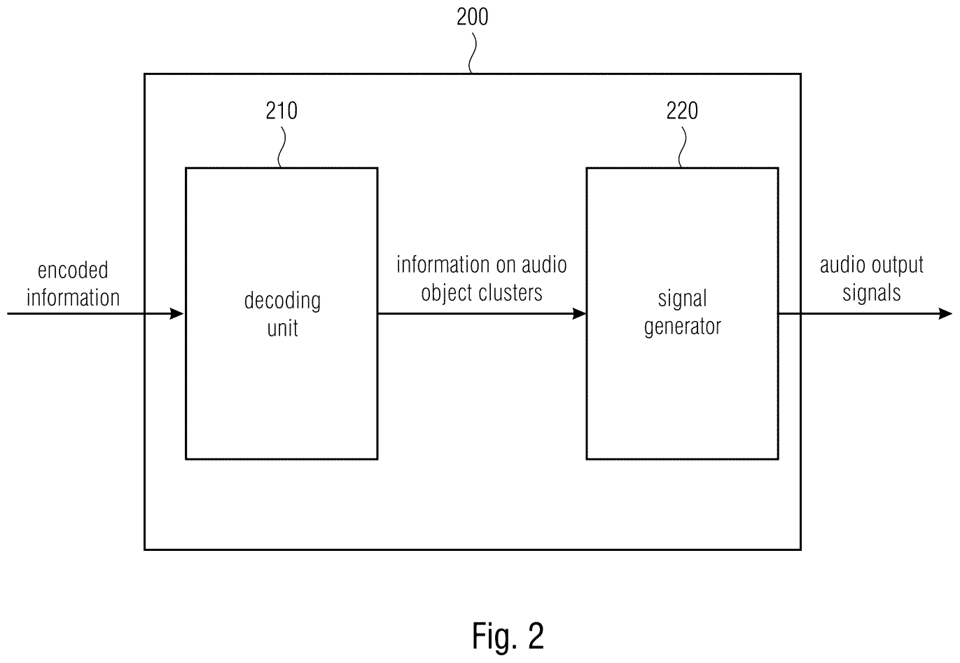

FIG. 2 illustrates a decoder 200 according to an embodiment.

The decoder 200 comprises a decoding unit 210 for decoding encoded information to obtain information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model.

Moreover, the decoder 200 comprises a signal generator 220 for generating two or more audio output signals depending on the information on the two or more audio object clusters.

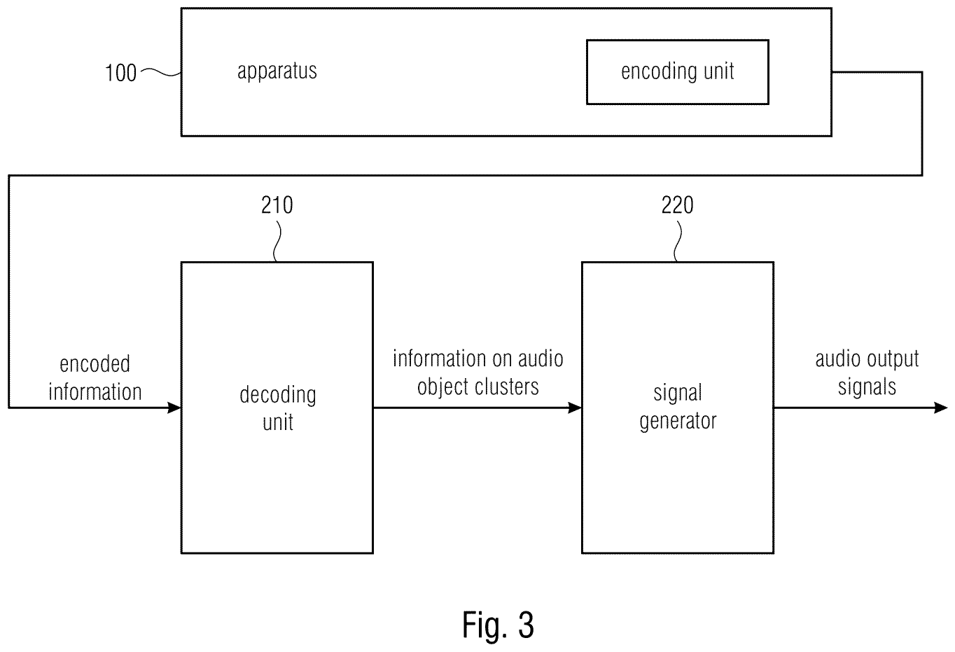

FIG. 3 illustrates a system according to an embodiment.

The system comprises the apparatus 100 of FIG. 1. The apparatus 100 of FIG. 1 further comprises an encoding unit for generating encoded information which encodes information on the two or more audio object clusters.

Moreover, the system comprises a decoding unit 210 for decoding the encoded information to obtain the information on the two or more audio object clusters.

Furthermore, the system comprises a signal generator 220 for generating two or more audio output signals depending on the information on the two or more audio object clusters.

Before describing embodiments in more detail, some background considerations are described on which embodiments of the present invention are based.

Now, perceptual models are considered and an overview over perceptual models that are the basis for the clustering algorithms and methods according to embodiments is provided.

The presented psychoacoustic model may, e.g., comprise the following core components that correspond to different aspects of human perception, namely, a 3D directional loudness map, a perceptual coordinate system, a spatial masking model, and a perceptual distance metric.

At first, a 3D Directional Loudness Map (3D-DLM) is described. The underlying idea of a Directional Loudness Map (DLM) is to find a representation of “how much loudness is perceived to be coming from a given direction”. This concept has already been presented as a 1-dimensional approach to represent binaural localization in a binaural DLM (Delgado et al. 2019). This concept is now extended to 3-dimensional (3D) localization by creating a 3D-DLM on a surface surrounding the listener to uniquely represent the perceived loudness depending on the angle of incidence relative to the listener. It should be noted, that the binaural DLM had been obtained by analysis of the signals at the ears, whereas the 3D-DLM is synthesized for object-based audio by utilizing the a-priori known sound source positions and signal properties.

Now, a perceptual coordinate system (PCS) is presented. Source localization accuracy in humans varies for different spatial directions. In order to represent this in a computationally efficient way, a perceptual coordinate system (PCS) is introduced. To obtain this PCS, spatial positions are warped to correspond to the non-uniform characteristics of localization accuracy. Thereby, distances in the PCS correspond to “perceived distance” between positions, e.g. the number of just noticeable differences (JND), rather than physical distance. This principle is similar to the use of psychoacoustic frequency scales in perceptual audio coding e.g. such as Bark-Scale or ERB-Scale.

Now, a spatial masking model (SMM) is described. Monaural time-frequency auditory masking models are a fundamental element of perceptual audio coding, and are often enhanced by binaural (un-) masking models to improve stereo coding. The spatial masking model extends this concept for immersive audio, in order to incorporate and exploit masking effects between arbitrary sound source positions in 3D.

Regarding a perceptual distance metric, it is noted that the abovementioned components may, e.g., be combined to obtain perception-based distance metrics between spatially distributed sound sources. These can be utilized in a variety of applications, e.g., as cost functions in an object-clustering algorithm, to control bit distribution in a perceptual audio coder and for obtaining objective quality measurements. These metrics address questions like, “how perceptible is it if the position of a sound source changes?”; “How perceptible is the difference between two different sound scene representations?”; “How important is a given sound source within an entire sound scene? (And how noticeable would it be to remove it?)”

In the following, developed clustering concepts and algorithms are presented.

In applications that use object-based audio, it is desirable to reduce the number of objects that are needed to represent the sound scene while maintaining a high perceptual quality, in order to improve the efficiency for transmission, storage as well as the computational complexity for rendering applications. Therefore, perception-based clustering of audio objects may, e.g., be employed. In other words, based on the presented perceptual models, audio objects with similar perceptual properties may, e.g., be grouped and combined into fewer audio objects.

Depending on the use-case, there is a wide range of the desired target properties and how much the number of objects in a scene is reduced. In the field of audio coding, there are the well-known paradigms that aim at constant quality with variable bit rate (VBR), or at a constant bit rate (CBR), resulting in variable quality. Correspondingly, object clustering may, e.g., be configured to aim at constant quality, which will result at a variable number of clusters (=output objects), or at a constant number of concurrent objects at variable quality.

The most conservative approach aims to only remove redundancy and irrelevancy in a scene representation. This means that only objects which can be combined without introducing audible changes to the scene may, e.g., be consolidated in order to reduce the number of objects without affecting the perceived quality (“transparent” clustering). This approach may, e.g., also be extended to further reduce the object count by clustering objects within a chosen threshold of a perceptual distance metric, i.e. a maximum distance (e.g. a multiple of JND distance). These approaches may, e.g., result in a variable number of clusters and thus output objects.

On the other hand, in many applications the maximum number of objects may, e.g., be determined by external factors such as maximum transport channels in audio codec profiles, or number of signals which can be processed by a real-time renderer. Depending on the use-case, this can result in demanding requirements to the reduction factor, e.g., a movie scene which has been authored with up to 128 objects might be reduced to a channel bed plus four to eight objects (e.g. in order to be transmitted in a maximum of 16 transport via MPEG-H LC Level 3 as e.g. 7.1+4 channels+4 objects). For these use-cases, a clustering algorithm may, e.g., result in a given constant or maximum number of clusters.

A maximum number clustering may, e.g., directly be derived from the maximum distance based approach by increasing the allowed distance until the number of resulting clusters is below the limit. However, this can result in ambiguities and possibly a number of output clusters which is below the target, which would result in unnecessary reduction of quality.

According to an embodiment, an iterative, hierarchical clustering algorithm is presented, in which the number of objects in a scene is reduced by iterative, pairwise grouping with a perceptual distance as optimization criterion. Furthermore, for very severe reduction factors, it may, e.g., be beneficial to regenerate the overall sound scene in a “generative” approach by approximating the spatial distribution of loudness rather than individual sound sources.

In the following, a Gaussian mixture model (GMM) based clustering is considered.

The mixture model based clustering may, e.g., be considered as a generative approach. E.g., a given DLM is approximated by a given number components in a GMM. In other words, this approach assumes a given/predefined (maximum) number of sound sources that are available and aims to recreate the overall loudness distribution of a given/predefined scene rather than looking at individual sound source positions. It can therefore be considered to be a scene-based approach (and is not to be confused with Ambisonics which is often referred to as “scene-based audio”).

This approach is especially beneficial when a high number of objects needs to be represented by only a few cluster positions (e.g. for low-bitrate applications), e.g., when typically many input objects will be assigned to one cluster. Conversely, recreating a high number of positions by a similarly high number of distributions is not computationally efficient.

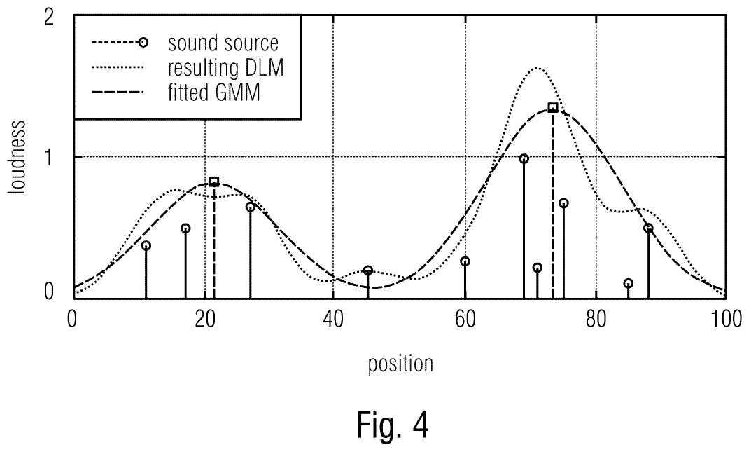

FIG. 4 illustrates a simplified 1D example, in which a DLM generated by ten sound sources is approximated by a GMM with only two components.

Such a GMM based approach not only yields centroid positions and memberships, but also the probabilities that a point belongs to a given cluster. This can be advantageous to identify cases where the cluster membership is ambiguous (as, e.g., the sound source ca. at position 45 in the illustrated example). This information can be used to employ temporal stabilization via a hysteresis to fluctuation of membership assignment, and can even be used to enable soft clustering approaches, where in the context of audio object clustering, an object might be mixed into two output clusters.

Expectation-maximization (EM) algorithms are a well-known approach fitting a GMM to the distribution density of a set of given data points. An underlying model assumption may, e.g., be that the input data points have been placed by a random process with a probability distribution density which is a mixture of Gaussian distributions within a given coordinate system. In other words, the GMM aims to approximate the probability that a data point is placed at a given position.

An EM algorithm is an iterative approach to fit such a probability distribution to a given set of data points. In principle, the approach is similar to the well-known k-means clustering algorithm, which iteratively assigns points to the closest centroid position, and then updates the centroid positions based on the updated cluster members. Simply put, an EM algorithm is a ‘soft’ version of that approach, where instead of assigning ‘hard’ memberships of points to clusters, the parameters of Gaussian distributions are updated (centroid positions and standard deviation), based on the probability of a point belonging to each of the individual Gaussian components. Thus, in each update step, a point can influence the centroid position of more than one component. Vice versa, the EM algorithm result not only yields centroid positions and memberships, but also the ‘spread width’ (standard deviation) of the individual components and thereby the probabilities that a point belongs to a given cluster.

The EM algorithm comprises two name-giving steps, expectation and maximization, which are iteratively repeated until a convergence criterion is reached. As a high-level explanation (omitting the underlying statistics) the iteratively repeated steps are the expectation step and the maximization step.

In the expectation step, distribution parameters, e.g., a centroid position and e.g., a standard deviation, are assumed as given, and membership probabilities are calculated, e.g., the probability of each point to belong to each of the individual Gaussian components.

In the maximization step, the membership probabilities are assumed as given, and distribution parameters are updated, e.g., centroids and e.g., distribution width from mean value and variance, are calculated and are weighted by the respective membership probability

As exit criterion for the iteration, the log-likelihood of the distribution may, e.g., be used as a ‘goodness of fit’ measurement. Also the iteration count may, e.g., typically be limited in order to control maximum computation times.

Existing DLM-based object clustering has limitations. Fitting a GMM on data points is a common task in principle for which algorithms and toolboxes are available (e.g., provided by Matlab toolboxes). However, the typical application is to fit a model to a random distribution of unweighted points with varying density. Conversely, the DLM represents a regular grid of points with varying weight. This disparity prevents the straightforward use of available algorithms and toolboxes for GMM fitting. In order to be able to make use of existing toolboxes, this mismatch can be approached by data preprocessing, e.g., achieved by emulating a varying distribution density by repeating points based on the DLM value. However, this results in a substantial bloating of data due to point repetition, and is therefore not efficient on memory requirements and computational complexity. Furthermore, the chosen sampling grid of the DLM can impede the result of feeding preprocessed data into existing GMM fitting algorithms: if the sampling grid and therefore the relative point density is not uniformly distributed, the resulting GMM's centroids will be biased towards areas of higher sampling point density, for example, concentrated at the poles for uniform sampling in azimuth/elevation domain.

As a side remark, it should be noted that the analogy in statistic approaches of using EM-algorithms for grid-based data, as it is needed for the DLM fitting, is analysis of histogram data rather than underlying point distributions. However, interestingly, there is not much literature on using EM-Algorithms for grid-based/histogram data. Since histograms are generated from the underlying data in the first place, binning data into a histogram decrease accuracy and would only be done e.g. for computational efficiency, or for data acquisition reasons (e.g. CHIANG et al.: “Where are the passengers? A Grid-Based Gaussian Mixture Model for taxi bookings”, 2015), and seems not to be supported by any available toolbox. Also, histogram-based approaches assume a uniformly sampled grid, which is not necessarily given for a DLM sampled on a sphere.

Furthermore, fitting a model to represent the probability of a random distribution results in a distribution for which the sum (or integral) over all positions is normalized to unity, i.e., equal to one. However, in a DLM the overall sum is determined by the sum of the loudness of the individual sound sources, which is not normalized to a constant value.

Therefore, an enhanced EM-algorithm, modified to fit GMM for a set of weighted points in an arbitrary grid of positions has been developed.

For a PCS based DLM, the distances are actually modeled to fit the Euclidean distances between two given points rather than angular distances (e.g. accounting for front/back confusion). Therefore, the underlying distribution model is a 3D-gaussian distribution, not a surface distribution (like a spherical distribution).

In the following, an enhanced EM-Algorithm according to an embodiment for weighted data points is described.

As a particular embodiment, a detailed exemplifying operation of the developed algorithm is shown in the following pseudo-code representation:

The algorithm parameters may, e.g., one or more or all parameters of the following:

The input parameters may, e.g., comprise
a pre-generated loudness map (sampled grid point positions pᵢ and corresponding loudness values DLM(pᵢ)),
a target number of clusters k.

The output parameters may, e.g., comprise:
cluster centroid positions c_l
membership probabilities for each input position to each component clusterProb(i,l)
“hard” membership assignment mem(i) of positions to clusters (to provide interface compatibility with other clustering approaches that yield centroids and memberships)
distribution parameters to that determine the Gaussian Components of the model DLM: E.g., centroid positions c_l; spread parameters sigma_l (=standard deviation of Gaussian distribution); weight parameters a_l (scaling weight to represent different loudness for different components)
resulting GMM approximation of DLM distribution DLM_GMM(pᵢ)
an error metric: sum of squared errors (SSE) between input DLM(pᵢ) and approximated DLM_GMM(pᵢ) distribution

In the following, the algorithm initialization according to an embodiment is described.

As a general remark, it is noted that since the membership probabilities and corresponding contribution weights of the individual points to the clusters are not available at initialization time (since they are a result of the probability estimation), the initialization is performed using “hard” memberships and geometric distances. The Gaussian components' weight and width distribution parameters are then determined and refined in the subsequent iteration steps.

For the initialization of centroid positions c_j (c_1 . . . c_k), multiple options exist. For example, the initialization of centroid positions may, e.g., be conducted as follows: For the first processed frame, the k loudest input objects may, e.g., be picked, initialization with random positions may, e.g., be conducted, performing (computationally faster) k-means clustering algorithm with random initialization may, e.g., be conducted, and the result may, e.g., be used as better guess for initial centroid positions, to increase convergence speed of EM-algorithm (e.g., coarse clustering via k-means, subsequent EM-algorithm for refinement). In subsequent frames, initialization with previous centroid positions for improved temporal stability may, e.g., be conducted, and re-initialization with one of the above methods e.g. based on a scene change detection may, e.g., be conducted. Optionally, multiple instances of the EM-algorithm with different initialization methods may, e.g., be run (e.g. previous positions and current loudest objects), and pick result with lower error metric.

Membership mem(i) Initialization may, e.g., be conducted by assigning all points nearest centroid, e.g., based on Euclidean distance d_i(j)=d(p_i, c_j)=|p_i−c_j|, or may, e.g., be already provided if initialization is done via k-means.

Distribution width parameter sigma initialization may, e.g., be calculated as standard deviation, as a first option, based on distribution of initial centroids i.e. the same for all components: sigma(j,dim)=std({c_1(dim), . . . c_k(dim)}), or, as a second option, based on the standard deviation of the positions of the initialized cluster members sigma(j,dim)=std(p(mem==j)). It should be noted that for multi-dimensional data, the Gaussian distributions are assumed to be separable in each dimension, i.e. the distribution width, controlled by the standard deviation parameter sigma(j,dim) is determined independently for each dimension dim cluster index j (I.e. 3 degrees of freedom in case of a 3D-DLM, could be reduced to 2D e.g. for use cases with only sound sources in horizontal plane).

Regularization of sigma may, e.g., be conducted, e.g., limited to values between regmin, regmax (for example, [1, 5]), for stability, in to prevent excessively narrow or excessively wide distributions, which would impede the algorithm's convergence. (e.g., if during initialization one cluster would only have one member, the distribution width would effectively be zero, preventing other members to be agglomerated into the cluster). Besides the algorithmic stability, this is also motivated by psychoacoustic considerations, since the distribution width, representing the membership probability, i.e. vice versa “uncertainty”, should not be narrower than the localization accuracy of the underlying perceptual model.

A weight a_j may, e.g., be assigned to each cluster to represent differences in distribution weighting.

To initialize the weights a_j, first the joint probability density function (PDF) over all dimensions for each data point jointPdf(i) may, e.g., be calculated as the product of the individual PDF given by the PDF of a Gaussian Normal distribution normpdf(x,mu, sigma), using the corresponding distribution parameters c_i, sigma as initialized above:

$$jointPdf ( i , l ) = {\prod }_{dim = 1}^{3} normpdf ( {p}_{i , dim} , {c}_{l} , σ ( j , dim ) )$$

The cluster weights a_j may, e.g., then be calculated from ratio of the sum of the jointPdf weighted by the data point's values to the unweighted sum of the jointPdf, e.g.,

$${a}_{l} = \frac{{\sum }_{i} D L M ( {p}_{i} ) \cdot jointPdf ( i , l )}{{\sum }_{i} jointPdf ( i , l )}$$

The sum over all distributions sumPdf(i) at the data point positions may, e.g., be calculated as the sum over the weighted distributions of all Gaussian Components, in order to obtain an approximation of the overall DLM(p_i):

$$sumPdf ( i ) = {\sum }_{l} {a}_{l} \cdot jointPdf ( i , l )$$

In the following, the iterative steps according to an embodiment are described:

In the expectation step, the probability of each datapoint belonging to a given cluster clusterProb(i,j) may, e.g., be calculated as the ratio of the contribution of the individual cluster to the overall PDF:

$$clusterProb ( i , j ) = jointPdf ( i , j ) ⋆ alpha ( j ) / sumPdf ( i )$$

In other words, this is analogous to calculating the ratio between the individual components' DLM to the overall DLM.

In the maximization step, centroid positions c_l may, e.g., be updated as the weighted average position, weighted by the probability of all points to belong to a given cluster (individually for each dimension)

$${c}_{l} = \frac{{\sum }_{i} clusterProb ( i , j ) \cdot {p}_{i}}{{\sum }_{i} clusterProb ( i , j )}$$

for improved numerical stability (and avoiding division by 0), a small offset may, e.g., be added, and the positions are additionally weighted by the data point values, e.g.,

$${c}_{l} = \frac{{\sum }_{i} ( clusterProb ( i , j ) \cdot DL M ( i ) \cdot {p}_{i} + ε )}{{\sum }_{i} ( clusterProb ( i , j ) \cdot DLM ( i ) + ε )}$$

Optionally, in order to represent data that originally has been sampled on a sphere or ellipsoid, the centroid positions are projected to the spherical surface, e.g. assuming a distribution on a unit sphere, by normalizing the positional vectors to unity

Similarly, distribution width sigma_l may, e.g., be updated, based on average weighted variance, e.g.,

$${σ}_{l} ( j , dim ) = \sqrt{\frac{{\sum }_{i} ( clusterProb ( i , j ) \cdot DLM ( i ) \cdot {( {p}_{i , dim} - {c}_{l , dim} )}^{2} + ε )}{{\sum }_{i} ( clusterProb ( i , j ) \cdot DLM ( i ) + ε )}}$$

jointPdf, cluster weights a_j, and sumPdf may, e.g., be updated as above for initialization.

The expectation and maximization steps may, e.g., be iteratively continued, e.g., until an exit criteria is fulfilled.

The exit criteria may, e.g., be that a maximum number of iterations is reached (e.g. 50). Such an exit criteria ensures an upper limit for overall computation time.

Or, the exit criteria may, e.g., be a criteria based on a sum of squared errors (SSE) between DLM and sumPdf(instead of the log-likelihood which is commonly used in EM-Algorithms for unweighted data). For example, the exit criteria may, e.g., be that the overall SSE is small enough, i.e. the fitted model is sufficiently good. Or, the exit criteria may, e.g., be that the SSE is no longer decreasing (i.e. the SSE difference between two consecutive iterations is below a given threshold, e.g. 0.1*std (DLM)), e.g., the algorithm has converged and more iterations do not bring further improvement.

Regarding the output data collection, after termination, the algorithm may, e.g., collect the model parameters and generates additional output values, e.g., distribution parameters, (for example, centroid positions c_l; spread parameters sigma_l; weight parameters a_l), and e.g., membership probabilities for each position to each component, Additionally, a “hard” membership assignment mem(i) may, e.g., be determined based on the highest membership probability for each point, in order to provide interface compatibility with other clustering approaches that also yield centroids and memberships.

The enhanced version of the EM-algorithm yields centroid positions and “hard” cluster memberships for the given input positions, which are the common output parameters of a clustering algorithm, as well as “soft” clustering by providing membership probabilities. Furthermore, it provides parameters of a weighted GMM model, which approximates the input distribution (DLM). Main enhancements over state-of-the-art EM-algorithms are the incorporation of weighted input points with variable overall weight, consideration of input in uniform or non-uniform grid positions, and adjustments to fit positions on spherical surfaces.

In the following, a hierarchical clustering is considered.

Generative clustering approaches such as the GMM-based approach can be very efficient in order to fit a low number of clusters to a high number of input objects. However, the generative approach does not scale well for higher cluster numbers (and thus target quality), since computational complexity increases with the number of target clusters. On the one hand, the number of computations for the mutual probability estimation increases; on the other hand, due to the increased degree of freedom more iterations may be needed to converge to a stable solution. E.g., if the target number of clusters is already close to the original number of input objects, a high number of iterations may be needed to converge to a solution in which most objects are left unchanged in the end.

According to an embodiment, an iterative, hierarchical clustering algorithm is introduced. In simple terms, it iteratively selects the two “closest” objects (based on a psychoacoustic metric) and combines them, until a target number of clusters is reached and/or until a minimum distance threshold between closest objects is exceeded. Thus, in each iteration the number of output objects is reduced by one, so it will reduce N objects into k clusters within (N-k) iterations, and thus provides a deterministic computational complexity.

The general concept of hierarchical clustering is well-known in literature. The developed algorithm according to embodiments comprises concepts and enhancements which may, e.g., apply the known concepts in the context of clustering of object based audio, but, according to an embodiment, may, e.g., use (one or more) psychoacoustic metrics as a cost function.

The distance metric for hierarchical clustering may, e.g., be given by the linkage within a cluster, e.g., which distances are considered as a cost function for members within a cluster. Common linkage models are ‘complete linkage’, e.g., the maximum distance between any two objects in a cluster, or ‘centroid linkage’, e.g., given by the distance between the respective centroids.

In the presented algorithm according to an embodiment, a greedy, iterative approach may, e.g., be chosen, where pairwise distances are minimized and then centroids are updated.

This corresponds to a centroid linkage model.

In the following, a hierarchical clustering algorithm according to an embodiment is described.

The input parameters and pre-processing may, e.g., comprise
input object positions pᵢ,
input object energy (optionally perceptually weighted, e.g. by pre-filtering in time domain to apply A-weighting),
previous centroid positions and object membership in subsequent frames,
target condition (only one or both may be specified), e.g., a number of maximum clusters k, or, e.g., an upper limit of distance metric threshold.

The output parameters may, e.g., comprise
cluster centroid positions c_l,
cluster memberships mem(i).

In the following, the algorithm initialization according to an embodiment is described.

A masking model between input objects may, e.g., be calculated. A cost function/distance metrics, e.g., an inter-object distance matrix, may, e.g., be calculated. E.g., a baseline model may, e.g., be determined, for example, Euclidean distances between object positions in world coordinates. Or, e.g., a perceptually enhanced model may, e.g., be determined, for example, Euclidean distances between object positions in PCS. Or, e.g., a full model may, e.g., be determined, for example, pairwise perceptual distances D_perc, under consideration of a masking effect from the entire scene may, e.g., be calculated.

In the following, iteration according to an embodiment is described.

It should be noted that the iterative processing may, e.g., be done ‘in-place’, e.g., two objects are consolidated into the index position of one of the objects, and the other one is marked as invalidated. Thereby, an updated centroid is formed, which may, e.g., be regarded by the next iteration step like any other object. In other words, during the iteration, each object may, e.g., be considered to be a centroid and vice versa, so the terms are used synonymously here. The iteration may, e.g., comprise:

A smallest distance in distance matrix may, e.g., be selected.

Corresponding two objects may, e.g., be merged. The objects may, e.g., be consolidated into the index of one of the two objects based on one or more of the following criteria: E.g., into smaller object index position (fallback), e.g., into object/cluster that has more energy, e.g., into cluster that has already more members. The centroid position may, e.g., updated as average position of the two merged objects, weighted by object energy, or, as alternatives, as a geometric middle position, or based on the weighted average of all member positions.

Parameters and distance metrics may, e.g., be updated. It should be noted that the updated centroid will be treated like any object in the next iterations. All row and column entries in the distance matrix for the “removed” object may, e.g., be invalidated, e.g., marked to be excluded from further search iterations. An energy of a combined object may, e.g., be calculated as sum of merged object energies. Masking thresholds at the new centroid position may, e.g., be updated, for example, in a high complexity model by re-calculating masking for updated positions, or, for example, in a low complexity model, by estimating masking thresholds at centroid position as maximum, sum, or weighted average of merged objects' thresholds. A PE (perceptual entropy) of the consolidated object from updated energies and masking thresholds may, e.g., be calculated. Row and column of the distance matrix to update distances to consolidated object, as calculated in the initialization step for input objects may, e.g., be recalculated.

The iteration may, e.g., be continued until an exit condition is fulfilled.

An exit criteria may, e.g., be whether the target number of clusters is reached. Or, an exit criteria may, e.g., be whether the minimum distance is above a given threshold, for example, 1 JND.

How the exit criteria are combined may, e.g., depend on the target use-case in order to achieve different goals, for example, constant quality, constant number of output clusters, or, as a compromise, mostly constant quality with a maximum number of clusters (which is assumed to be only rarely hit).

Therefore, the exit criteria can be combined in different AND/OR conditions to achieve one of the following options:

A first basic case is a ‘constant rate’ case. The iteration may, e.g., be continued until target number of clusters is reached. This yields k clusters (unless input number of objects already was N<=k), but results in varying quality, depending on the number and distribution of input objects.

A second basic case is a ‘constant quality’ case. The iteration may, e.g., be continued until the smallest distance in the distance matrix exceeds a given threshold. This results in (approximately) constant quality and can e.g. be used to remove only differences that are already below or close to JND, or below a suitable tolerance for a given use-case. However the number of output clusters varies, and can worst-case be equal to the input number of objects.

A first combined AND case is a ‘constant maximum rate with irrelevancy reduction’ case (low target number of clusters, low distance threshold). The iteration may, e.g., be continued until the target number of clusters is reached. If the minimum distance is below a given threshold (e.g. one JND), the iteration is continued to remove irrelevancy from the scene.

A second combined AND case is a ‘constant quality with upper rate limit’ case (high target number of clusters, high distance threshold). In terms of (Boolean) definition of exit criteria identical to the first combined AND case; however, the main parameter is the distance threshold to primarily achieve constant quality, while the target number of clusters is set relatively high to provide an upper limit of the number of output clusters (for example, in order to not exceed transport channel or renderer input capabilities).

A combined OR case is a ‘constant rate with quality impediment limit’ case. This case is mentioned mostly for completeness, since its possible use-cases are limited. The iteration may, e.g., be continued until either one of the exit criteria is fulfilled, i.e. if the cluster number or the distance metric indicates to exit. This leads to a variable-rate with variable-quality output. Possible use cases are applications where the number of clusters (i.e. rate) is intended to be mostly constant, but excessively large impediments of the quality are to be avoided, therefore temporarily more output clusters are allowed. (e.g. for file-based storage, where the average rate is more essential than the peak rate)

In the following, a JND (just noticeable difference) based clustering is considered.

In contrast to a “constant rate” clustering approach with a given maximum number of clusters, a JND based clustering approach is aimed at only removing irrelevancy and redundancy from a scene, in order to reduce computational complexity and/or transmission bitrate, while maintaining perceptually transparent results or at least a constant quality (similar to VBR modes in perceptual audio coders).

This may, e.g., be achieved by only clustering objects together where the positional change does not exceed a given threshold, e.g. one JND.

This approach can be used to remove irrelevant separations between objects, which are already closer to each other as the localization accuracy of human hearing can resolve. Therefore, it can even be performed based only on position metadata, without needing measurements of the actual signal.

JND based clustering may, e.g., be conducted at different levels of strictness:

With level 1 centroid distance, the distance between a cluster centroid and a clustered object must not exceed a threshold.

With level 2 inter-object distance, the pairwise distance between all objects in a cluster operation must not exceed a threshold.

With Level 3 sum distance, the combined change in all objects in the auditory scene must not exceed a threshold (e.g. in order to achieve perceptually transparent quality)

It should be noted that level 1 and 2 approximately correspond to ‘centroid linkage’ and ‘complete linkage’ in a hierarchical clustering approach, while level 3 corresponds to an overall scene analysis task (for example, measuring sum of distances or overall DLM divergence).

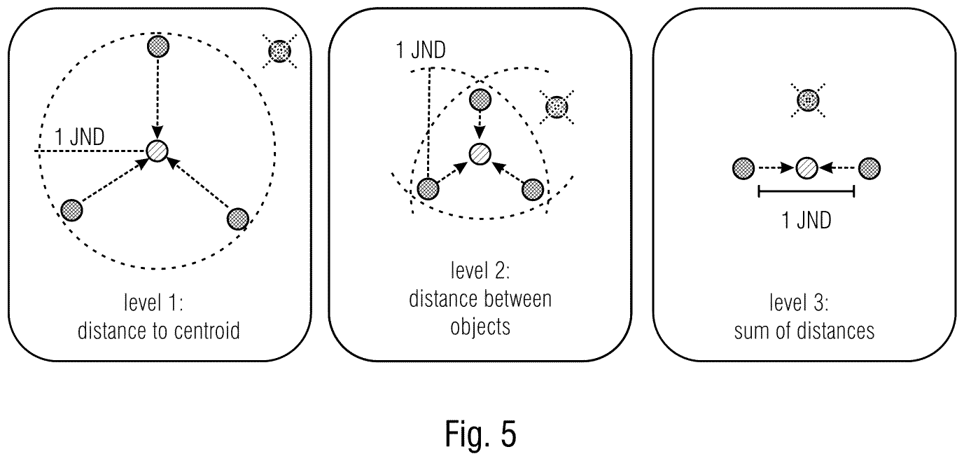

FIG. 5 illustrates three different distance model levels of JND based clustering according to embodiments (captioned L1 to L3).

In the given example, for level 1, all objects that may, e.g., be within JND distance of the resulting centroid can be combined. In level 2, the objects may, e.g., have to be closer to within JND distance of each other in order to be combined. In level 3, even though all objects are within JND distance, only two of the three objects may, e.g., be combined, because the sum of distances would otherwise exceed the JND.

Level 1 (centroid distance) may, e.g., be implemented as a variation of the hierarchical clustering algorithm described above, by setting no target number of clusters in the exit criterion, and to only consider the minimum entry in the distance matrix min (D_perc) to be below a given threshold, or alternatively only considering the perceptual spatial distance D_PCS to be below e.g. 1 JND, independent of masking and energy properties. The latter enables clustering in applications, where only positional metadata but no signal energies are known to the algorithm.

Level 3 (sum distance) may, e.g., be implemented, for example, via a hierarchical clustering algorithm, where the sum of distances may, e.g., be used as exit criterion instead of the minimum distance, or where the divergence of the DLM for the entire scene is used as exit criterion. It should be noted, however, that repeated calculation of DLM divergence results in high computational complexity and is therefore more suitable for encoding and conversion task rather than real-time applications.

Level 2 (object distance) poses a favorable compromise between the strictness of Level 1 and 3. Since it only depends on the initial object positions, it may, e.g., be implemented at low computational complexity and is therefore the recommended mode of operation in most applications. Since only the pairwise distance metrics between objects is considered, it may, e.g., be performed only based on one initial calculation of the distance matrix, without iteratively updating centroid positions and distances. To improve computational complexity of an object clustering system, such an object-distance based JND clustering may, e.g., be performed as a pre-processing step to reduce the initial number of clusters with low computational effort while maintaining transparent quality, before applying an iterative (hierarchical or GMM-based) clustering algorithm to achieve a target number of clusters. It should be noted that in general, there is no unique solution for such a clustering, as different groupings are possible (e.g. A+B, and B+C may be combined, but not A+C). Optimizing such a ‘complete linkage’ clustering problem towards minimizing the number of clusters is known in literature as ‘Exact Cover Problem’, which has been shown to be NP-complete. However, in the application of object clustering, the distance metric poses an alternative optimization criterion, based on which a greedy algorithm with low computational complexity is derived. The algorithm according to an embodiment, may, for example, be implemented as follows:

The initial distance matrix may, e.g., be calculated. Based on the use-case, this may, e.g., either be based on D_PCS to only consider spatial relations, or may, e.g., be based on D_perc, to additionally consider masking properties. The advantage of using D_PCS is that the JND clustering step is independent of the signal energy, i.e. it can be performed with very low computational complexity. The advantage of using D_perc is that the perceptual properties are modeled more accurately. Furthermore, since silent or inaudible object are assigned zero (or near zero) PE, this implicitly serves as a culling stage to consolidate irrelevant objects.

All entries (outside the main diagonal) in the distance matrix below a selected threshold may, e.g., be marked as pairs that may, e.g., potentially be combined in a Boolean combination matrix. The threshold can be selected depending on the use-case. For D_PCS distance based clustering, a threshold of 1 [JND] may be selected to only consolidate objects that are within the localization accuracy of human hearing. For a D_perc based clustering, additionally the masking properties are incorporated in the distance metric via the PE. Assuming a signal is exactly at the masking threshold, the resulting PE is log₂ (1+1/1)=1 [bit]. Therefore, likewise a threshold for D_perc of 1 [bit*JND] may be chosen as a simple approximation

All elements where the combination matrix is true may, e.g., be considered as candidate pairs.

The cluster creation may, e.g., be started by selecting, out of the candidate pairs, the one with the smallest entry in the distance matrix to initialize a cluster of two objects.

Iteratively objects may, e.g., be consolidated into the cluster by:
Selecting corresponding true entries in the combination matrix to create a candidate object list of objects (candidate list) that can be added to the cluster, e.g., objects that could be combined with all objects which are already in the cluster (though not yet necessarily all with each other).
Selecting a candidate object that has the smallest absolute distance, or smallest sum of distances to all objects in the cluster.
Adding the selected object to the current list, and updating the candidate list based on combination matrix for new object, e.g., removing objects from candidate list that may not be combined with the recently added object.
Iterating until no more entries remain in candidate list.

After the iteration has ended, the combination matrix for all objects in the recently created cluster may, e.g., be set to false, as they may no longer be assigned to another cluster.

The search may, e.g., be iterated for additional clusters beginning from the start cluster creation, until no true entries in combination matrix remain.

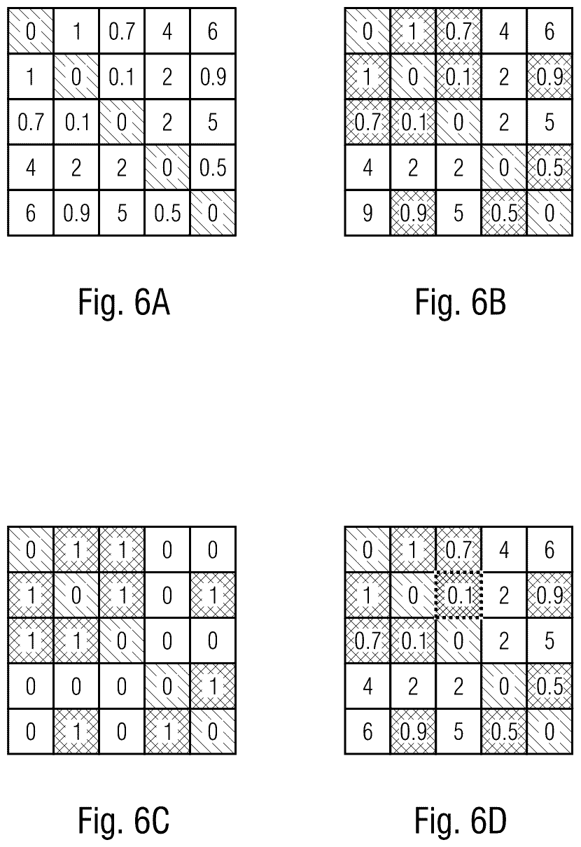

FIG. 6A to FIG. 6G illustrate a small-scale example for a Level 2 JND based clustering algorithm according to an embodiment.

FIG. 6A illustrates an initial distance matrix being calculated based on D_PCS.

FIG. 6B illustrates a distance matrix, where all entries outside the main diagonal in the distance matrix below a selected threshold are marked as pairs that may, e.g., potentially be combined in a Boolean combination matrix. In FIG. 6B, the selected threshold for marking the entries is ≤1.

FIG. 6C illustrates the combination matrix.

FIG. 6D illustrates a selection, out of the candidate pairs, the one with the smallest entry in the distance matrix to initialize a cluster of two objects.

FIG. 6E illustrates the finding of candidates in the combination matrix that can be combined with both objects in the cluster and adding them to the cluster until the list of candidate objects becomes empty (adding the first object in the illustrated example). FIG. 6E shows that for objects which are already assigned to a cluster, the respective rows/columns are analyzed to determine, which other object candidates can be combined with the objects of the cluster. For example, object 2 is combinable with (1, 3, 5); object 3 is combinable with (1, 2). Thus, (1, 3, 5) AND (1, 2)=(1). Thus, add object 1 to cluster=>candidate list is empty, continue to next cluster.

FIG. 6F illustrates the combination matrix, wherein entries in rows/cols (1,2,3) are invalidated, when the cluster is completed.

FIG. 6G illustrates the combination matrix, wherein a next cluster is selected. When the candidate list empty, the algorithm is done.

In the following, enhancements according to particular embodiments are considered.

At first, temporal stabilization according to an embodiment is described.

The presented clustering algorithms may, e.g., be performed on a frame-by-frame basis. Besides the perceptual distances in each frame, also the temporal stability of the scene in consecutive frames is crucial to the perceived quality. For example, it would also have an impact on the perceived quality, if object positions that were originally static would become unstable and start moving around, or audible ‘jumps’ would be introduced for originally smooth movement.

This leads to a trade-off in terms of optimization goals between minimization of momentary distance metrics versus temporal stability. For example, a sound source with an originally fixed position may, e.g., be considered, which is located around the ‘border’ between two clusters. Without temporal stabilization, small changes in the overall scene may cause the object's membership assignment to toggle between different clusters and thus result in frequent jumping between centroid positions. Such a destabilization may be perceived to be more annoying than a larger, but stable shift of the object's position.

For offline (‘file-to-file’) applications, for example, an encoding or conversion of pre-produced scenes (for example, cinematic object based audio mixes), some look-ahead or even a multi-pass encoding approach can be taken to optimize temporal stability. However, for real-time capability (for example, for interactive virtual reality (VR) applications), the temporal stabilization may, e.g., need to operate with little to no look-ahead, in order to avoid the introduction of additional delay to the system.

The temporal stabilization concepts according to some embodiments, which are presented in the following, do not require a look-ahead, as they rely on smoothing or applying a hysteresis with respect to past frames.

At first, the concept to employ temporal penalty in hierarchical clustering according to an embodiment is considered.

In order to avoid that object membership assignments toggle for objects where the optimal assignment is ambiguous, in an embodiment, an additional penalty is introduced for an object to change the cluster membership. Therefore, a temporal penalty may, e.g., be applied to the perceptual distance D_perc between objects that previously belonged to different clusters.

There are multiple options to implement a temporal penalty:

For example, a constant offset may, e.g., be added to D_perc (e.g. 30 [JND*bit]).

Or, for example, a multiplicative factor may, e.g., be applied to D_perc (e.g. 2).

Or, for example, the (crosswise) distances of the objects to the other cluster's previous centroids may, e.g., be employed, e.g., considering not only the distance between objects, but to the actual resulting centroid position (e.g. to consider that two objects that may be close to each other may just be at opposing sides at the border between two clusters).

Or, for example, the (weighted) distance between previous cluster centroids may, e.g., be employed. (e.g., taking the worst-case assumption that reassigning an object's membership would result in moving the object position from one centroid to the other, if the object's influence on the centroid position is small)

Now, DLM smoothing and centroid Initialization in GMM based clustering according to an embodiment is described.

For the GMM based clustering approach, the sluggishness of spatial hearing may, e.g., be taken into account by temporally smoothing the DLM. Therefore, a smoothed DLM is calculated as a weighted average of the current frame's DLM and the previous DLM (using either the previous frame's DLM for a short FIR type smoothing, or the previous smoothed DLM for an IIR type smoothing with longer falloff).

In addition to smoothing the DLM, the EM-Algorithm for the GMM fitting may, e.g., be initialized with the previous frame's centroid positions. In order to prevent temporal smearing e.g. for scene changes (e.g., a cut in a movie) a threshold for the overall difference in the DLM (e.g., SAD; sum of absolute difference) between two subsequent frames can be set to trigger a re-initialization of the centroid positions

Now, cluster permutation optimization according to an embodiment is described.

Besides the sound source position, also the temporal stability of the combined output signal is of importance, especially when the signal is transmitted via a perceptual audio codec. Even if the cluster centroid positions and object assignment remains mostly stable in a scene, small changes in the cluster membership may result in permutations of the cluster index order (since the cluster index order depends on the lowest member object index in hierarchical clustering, or can be the result of a random positions initialization in a GMM-based clustering approach).

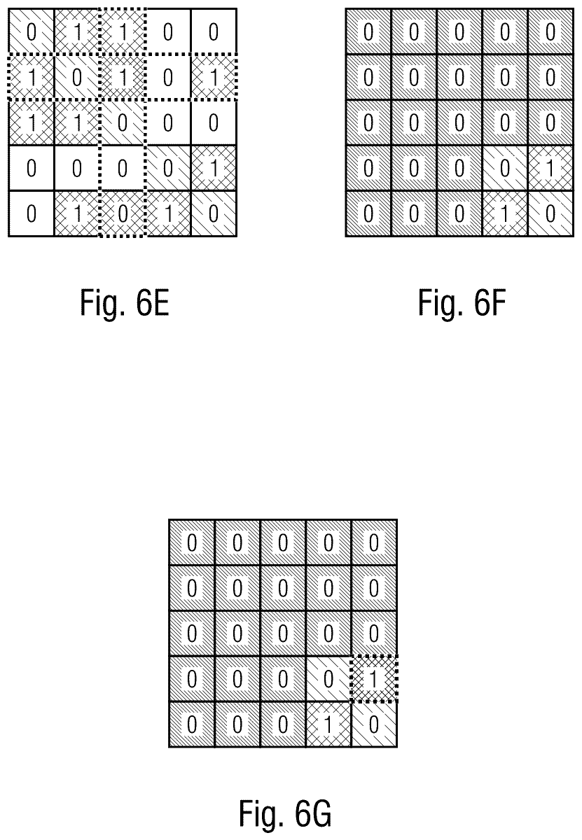

Such a permutation of is illustrated FIG. 7, where only the object in the middle slightly moves and is re-assigned from the left to the right cluster, but causes the cluster index to be swapped. In particular, FIG. 7 illustrates a cluster index permutation according to an embodiment due to slight changes in the scene (wherein the circles, to which the arrows in FIG. 7 point, are cluster centroid positions; and wherein the outer circles from which the arrows in FIG. 7 originate are input objects).

Typically the object signals may, e.g., be mixed into continuous waveforms, resulting in one signal (e.g., a transport channel) for each cluster. When object signals are assigned into different output signals in subsequent frames due to permutation, discontinuities may, e.g., be introduced into the output signals. Repeated crossfading between signals may, e.g., be needed, but can introduce transients in originally continuous signals (which are not actually perceived as transients in the overall audio scene). These ‘false’ transients can impede the performance of perceptual audio codecs and therefore shall be prevented. Besides affecting the output signal, the permutation/swapping of cluster indices may also lead to unnecessarily large and frequent changes of the corresponding centroid positions, which can cause artifacts in renderers (e.g. when positions are interpolated between frames), and may, e.g., reduce the efficiency of time-differential coding of cluster positions. Therefore, measures may, e.g., be taken to stabilize the assignment of cluster indices against permutation effects in consecutive frames.

Since the assignment of multiple objects to clusters and centroid positions may, e.g., vary over time, especially when larger changes in the scene occur, the permutation assignments can be ambiguous and needs an appropriate optimization strategy. However, the optimization goal of the permutation strategy depends on the use-case.

According to an embodiment, a baseline approach may, e.g., be employed to count and minimize the number of objects that are re-assigned between clusters.

Alternatively, in order to stabilize positional metadata, according to another embodiment, the sum of absolute or squared distances between the previous and current cluster centroids may, e.g., be minimized.

However, one explicit goal is to also stabilize the resulting output signal waveform. Thus, according to an embodiment, also signal properties may, e.g., be taken into account. As an illustrative example, e.g. a scene with two very loud objects, and additionally several nearly silent objects may, e.g., be considered. Here it may, e.g., be advantageous to keep the assignment of the loud objects stable (rather than minimizing the number of object re-assignments). Simply put, the optimization goal in this case is to keep as much signal energy assigned to where it previously was.

According to an embodiment, a permutation optimization is performed, with the goal to stabilize the energy distribution from object to clusters. First, the algorithm calculates a matrix of how much of the objects' energy is re-assigned in total between the individual clusters for a given object to cluster assignment in two consecutive frames. Based on this energy permutation matrix, a greedy algorithm is used to minimize the amount of energy that is re-assigned between clusters.

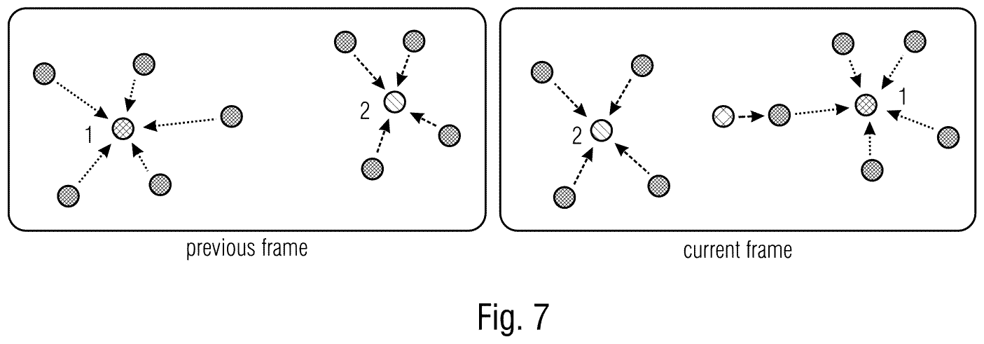

FIG. 8 illustrates cluster assignment permutation and optimization according to an embodiment. In particular, FIG. 8 illustrates an example for cluster permutation optimization according to an embodiment for an assumed case where ten objects are assigned to three clusters. The direction of the arrows shows the assignment of the objects to the clusters (e.g., to the cluster indices).

The object's cluster membership in the previous frame, corresponding to the previous cluster assignment, is shown in FIG. 8, a). The arrows' weights indicate the assumed energies of the objects in the current frame (energies are also given in numbers in the squares on the left).

FIG. 8, b) shows the cluster assignment for the current frame, as, e.g., resulting from a clustering algorithm where the cluster index order is determined by the lowest member object index. It should be noted that similar to the previous frame, the three loudest objects are still separately assigned to three separate clusters. However, since the grouping of the objects has changed, the assigned order has changed, which would result in a re-assignment of the output signals.

Therefore, according to an embodiment, the permutation optimization is performed, based on the energy permutation matrix shown FIG. 8, c). The highlighted cells indicate the optimized permutation assignment (e.g., row 1, column 2 indicates that most energy previously found in cluster 1 is now found in cluster 2).

The resulting, permutation optimized cluster assignment is shown in FIG. 8, d). Thus, in this (purposefully chosen) illustrative example the assignment of the three loudest objects remains stable with respect to the previous frame.

In detail, the algorithm according to an embodiment may, e.g., be implemented as follows:

Assuming a constant number of k clusters resulting from the clustering algorithm, a square energy permutation matrix M_Eperm of size k×k with values zero may, e.g., be initialized:

M_Eperm=zeros(k,k)

For each object index i, the current energy E(i) may, e.g., be added to the matrix entry corresponding to the row of the current and column of the previous cluster membership index mem_new(i), mem_prev(i):

$$M\_Eperm ( mem\_new ( i ) , mem\_prev ( i ) ) + = E ( i )$$

This may, e.g., result in a matrix that represents how much energy is reassigned to different indices. If no reassignments happen, this is reduced to a diagonal matrix. If the grouping of the objects remains the same, but permutations of the cluster index order occur, this results in a sparse matrix with only k nonzero entries. However, in the general case when different groups of objects are combined, this is not a sparse matrix (especially when many objects are combined into few clusters, i.e. N>>k).

The permutation may, e.g., be optimized by a greedy search in the permutation matrix, which, for example, comprises:
Initialize a permutation vector of length k with values zero.
Find maximum entry in matrix, resulting in indices rowMax, colMax.
Set permutation vector at respective position

permutation(colMax)=rowMax.
Set entries row rowMax and column colMax to zero (to indicate that the corresponding input index has already been assigned, and the output index is already taken)

$$M\_Eperm ( rowMax , : ) = 0$$

$$M\_Eperm ( : , colMax ) = 0$$

Iterate until all k permutations have been assigned.

The permutation may, e.g., be applied for the assignment of centroids and membership indices, by directly reassigning the centroid indices

c_perm(j)=c(permutation(j))

and by selecting and replacing the corresponding membership indices, e.g.,

$$if ( m e m ( i ) = permutation ( j ) ) then mem\_perm ( i ) = j$$

In applications where the objects' energy is not known to the algorithm, the algorithm may, e.g., be employed to minimize the number of objects that are re-assigned, by assuming all object energies to be equal to 1. Thereby, the energy permutation matrix M_Eperm is effectively used for counting objects.

In the following, cluster centroid position optimization according to an embodiment is described.

A clustering algorithm yields a membership (or probability of membership) for the individual objects, as well as cluster centroids. Clustering of 3D object positions can result clusters that contain objects in the front and in the back, especially when clustering based on perceptual metrics that exploit the limited spatial resolution of human hearing for elevation along the cones of confusion and front-back confusion.

Assuming that a centroid is calculated as the weighted average of positions that were originally on a convex hull around the listener, e.g. the unit sphere or a PCS ellipsoid, the resulting averaged positions can be within the sphere/ellipsoid. However, the output cluster position is desired to be also on the sphere in most applications. This is especially essential for loudspeaker playback scenarios where the sphere corresponds to the convex hull of loudspeakers, where this would otherwise need interior panning, which is not supported by many renderers (e.g. the VBAP implementation in MPEG-H). Therefore, the resulting cluster position needs to be shifted from the interior centroid position onto the sphere surface.

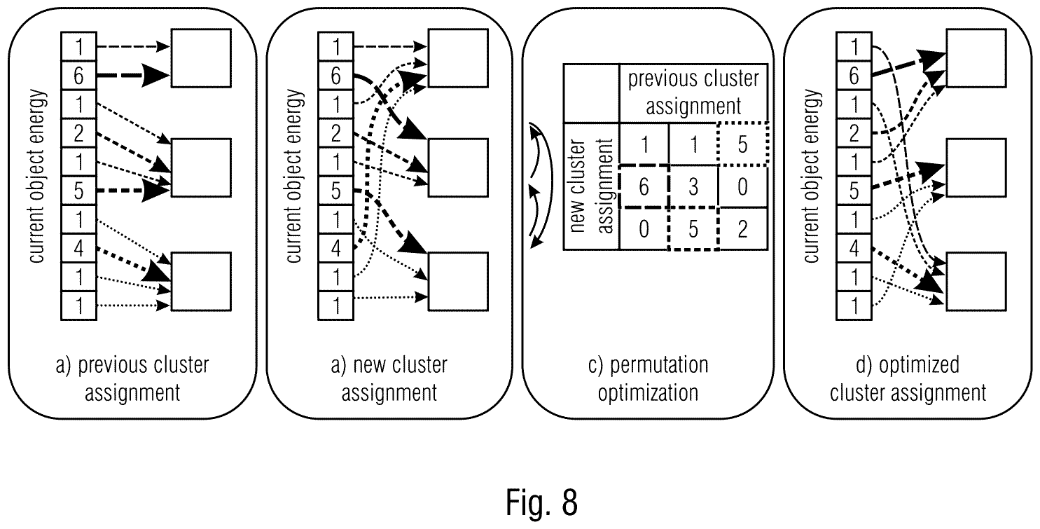

An approach would be to project a position to the unit sphere by normalizing its coordinate vector to the length of 1 (and warping from/to PCS coordinates before and after normalization) as illustrated in FIG. 9A to FIG. 9B. In particular, FIG. 9A illustrates a centroid projection in a unit sphere in the horizontal plane (‘top view’). FIG. 9B illustrates a centroid projection in a perceptual coordinate system (PCS) in the horizontal plane.

However, this would result in perceptually incorrect output positions, since positions that were initially on the same CoC (cones of confusion) are projected outwards. Thus, the left/right properties and thereby the binaural cues would change when combining sound source positions that perceptually only differ in spectral cues.

Therefore, according to an embodiment, a perceptually optimized placement of the cluster output position may, e.g., be utilized, where the left/right coordinate of the centroid position is preserved, and the cluster position is optimized along the corresponding cone of confusion.

The optimization along the CoC may, e.g., also depend on the intended playback scenario, e.g., a different strategy may, e.g., be chosen for binaural rendering than for loudspeaker rendering. Therefore, in the following, multiple options for centroid placement are presented.

In the following, normalization of a centroid position in a lateral plane according to an embodiment is described.

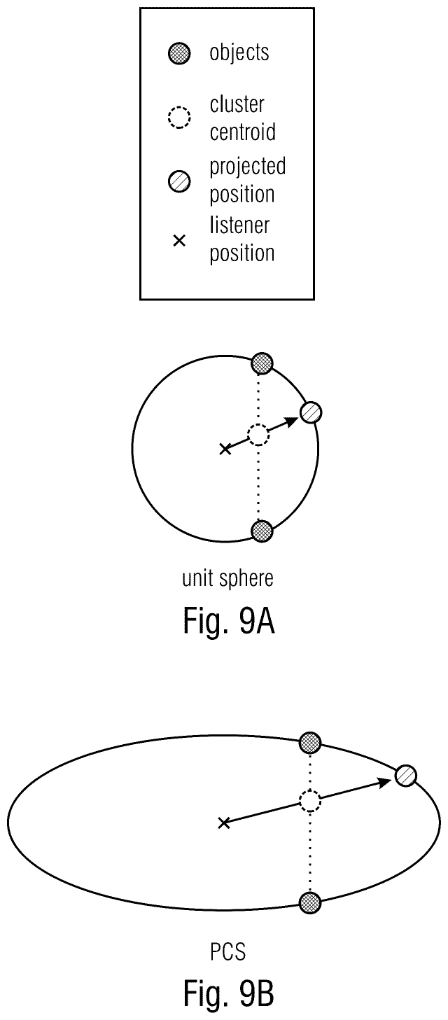

The baseline projection approach is to project the position outward by normalizing the position vector within the lateral plane to match the radius of the corresponding circle along the unit sphere as illustrated in FIG. 10.

FIG. 10 illustrates a centroid to cones of confusion projection in a lateral plane (‘side view’) according to an embodiment. It should be noted how objects that are in the front and back can result in a projection upwards.

The radius of the circle representing the CoC in the lateral plane is calculated and the centroid position coordinate vector is normalized within the lateral plane to match the radius of the CoC while keeping the original left/right coordinate.

When PCS coordinates are used, the centroid position is first converted back to unity coordinates.

(This mode can be advantageous for playback scenarios on sparse immersive loudspeaker setups, where the intermediate positions will be reproduced e.g. by amplitude panning. In this case, the object's energy will be redistributed to the front and back by exploiting the properties of the target rendering.)

Assuming the coordinate axis alignment: c=“front/back” (+1=front), y=“left/right” (+1=left), Z=“up/down” (+1=up) this is calculated as

$$azimuth = {sin}^{- 1} ( y\_centroid )$$

$$radius\_coc = cos ( azimuh )$$

$$radius\_centroid = sqrt ( {x\_centroid}^{2} + {z\_centroid}^{2} )$$

$$x\_proj = x\_centroid ⋆ radius\_coc / radius\_centroid$$

$$z \_proj = z\_centroid ⋆ radius\_coc / radius\_centroid$$

In the following, a height preservation mode according to an embodiment is presented.

It has been shown in psychoacoustic experiments that for vertical localization the spectral cues for ‘height’ are different from spectral cues for ‘front/back’. Or in other words, perceptually ‘above’ is not the middle between ‘front’ and ‘back’. Consequently, the baseline normalization of the centroid position within the CoC's lateral plane is not an ideal placement of the cluster position for many applications e.g. binaural rendering (where an HRTF that has spectral cues for “height” might be used to reproduce objects in front and back at ear level).

Therefore, a projection mode that preserves the height cues is introduced. In order to preserve the perceptual cues for height perception and resolving front/back confusion, both dimensions may, e.g., be considered separately.

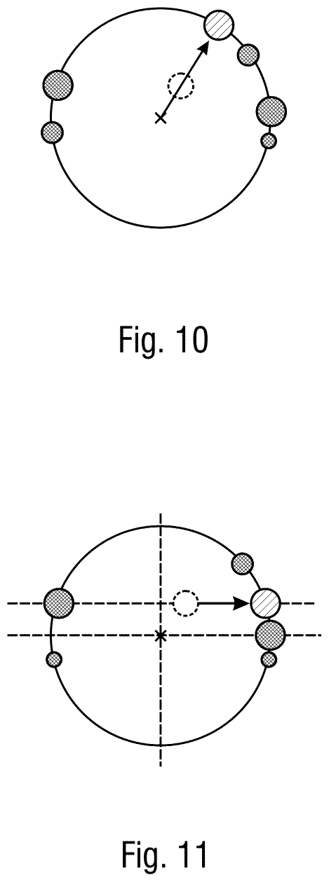

FIG. 11 illustrates a height preserving centroid projection to CoC in a lateral plane (=“side view”) according to an embodiment.

The height component may, e.g., be preserved from the centroid position, and the position may, e.g., be projected parallel to the horizontal plane onto the cone of confusion, as illustrated in FIG. 11. However, this means that there is a hard decision between projecting towards the front or the back. When the centroid is close to the transition between frontal and rear (e.g., y_centroid is close to zero), the projection position may jump between front and back, e.g., when the energies of the objects in front and back slightly vary over time. In order to stabilize the resulting position, a hysteresis may, e.g., be employed for the sign of the front/back coordinate to prevent the cluster position from toggling.

It should be noted that this mode is especially well-suited for binaural rendering applications. It prioritizes preserving the height cues over resolving the front back-confusion. While for loudspeaker rendering applications, the front-back confusion may easily be resolved due binaural cues introduced by slight head movement, for binaural rendering, only spectral cues may, e.g., be available for the resolution of front-back-confusion.

In the following, a spectral Matching (‘EQ-matching’) mode according to an embodiment is described.

The underlying idea for the spectral matching mode based on the fact is that positions along the CoC correspond to variations in spectral cues. Therefore, the perception of positional changes depends on the affected frequency regions, as well as the actual amount of spectral content that the signals have in the respective frequency regions. This means that a positional change will be easier to perceive for objects that more energy than others in the effected frequency regions and vice versa.

Therefore, the approach of spectral matching according to an embodiment optimizes the position in order minimizes the spectral difference of the sum of signals at the ears. Another interpretation is to consider the variations of the object positions among a CoC as a multiple equalizer (EQ) curves, and the task to be to match overall spectral envelope, therefore this mode is also dubbed ‘Equalizer (EQ) Matching’.

Since the EQ-matching mode considers the positions and signal properties of all member objects of a cluster, rather than only the centroid position, it may, e.g., need higher computational complexity than the centroid projection modes.

For set-up and calibration of this mode, appropriate frequency bands may, e.g., be selected, and average elevation gain curves for each band may, e.g., be calculated, for example, based on analysis of HRTF (head-related transfer function) databases (e.g., comparable to the calibration of PCS). During operation, signal energies may, e.g., be calculated for each band and object, and the optimized position is selected by numerical minimization of the difference in the sum of weighted energies, or by minimizing the ratio, e.g., the sum of logarithmic differences.

To improve computational complexity, a primary component analysis may, e.g., be utilized to derive a limited number of ‘Eigenspectra’ for positions along the CoCs. This can be interpreted as being preset equalizer curves for the whole spectrum that are adjusted in strength based on the position, rather than determining individual factors for each position and frequency band. These may, e.g., be correlated with the spectral envelope of the individual signals, in order to generate a lower dimension representation that can be minimized at lower computational complexity.

In the following, output signal mixing and processing according to some embodiments is described.

After the cluster membership and centroid positions have been determined, the object signals are combined in order to generate one output signal for each output cluster. An approach may, e.g., be to sum up the signals of all members within one cluster. However, in order to avoid audible artifacts and optimize perceived quality, further precautions and improvements need to be taken into account:

Since the cluster assignment is determined on a frame-by-frame basis, the membership can change from one frame to the next. A crossfade may, e.g., be applied when the membership changes to prevent audible clicks due to signal discontinuities.

There may be correlation between the objects' signals within a cluster, which may, e.g., result in positive or negative interferences in the downmixed signal. In order to achieve an energy-preserving downmix, the signal correlation may, e.g., be taken into account.

Clustering algorithms like GMM-based clustering yield not only a membership, but also a membership probability. Objects with ambiguous membership may, e.g., be mixed into more than one cluster to achieve a ‘soft’ clustering approach.

In the following, crossfading according to an embodiment is described.

When the membership of an object changes between subsequent frames, according to an embodiment, the downmix signal may, e.g., be crossfaded to prevent hard signal cuts that can cause audible clicks due to signal discontinuities.

In order to not require additional look-ahead for the cluster assignment in the next frame, the crossfade may, e.g., be performed at the beginning of the current frame.

To avoid unnecessary crossfading, each object's cluster membership for the previous and current membership may, e.g., be saved and compared. If, and only if the membership has changed, a crossfade is applied.

For crossfading, complementary window functions may, for example, be applied to fade in the object signal in the newly assigned cluster signal, and to fade it out from the previously assigned output signal. The crossfade may, e.g., be chosen to be energy preserving, therefore a sine-shape window may, e.g., be used. In an embodiment, the crossfade duration may, e.g., be long enough to prevent audible clicks, but may, e.g., be as short as possible to prevent audible lag in source position.

Therefore, in a particular embodiment, for example, a crossfade length of 128 samples (ca. 2.7 ms at 48 KHz sampling rate) may, e.g., be employed.

In the following, correlation-aware downmixing according to some embodiments is described.

The basic assumption for clustering of object based audio is, that the audio objects represent individual, uncorrelated sound sources, which are typically rendered as individual point sources by an object-based audio renderer (e.g. VBAP, vector base amplitude panning). However, there are cases that violate this assumption, e.g., where two or more object signals are correlated. This may, e.g., lead to positive or negative interference when calculating a downmix signal for correlated object signals within a cluster. Therefore, additional precautions may, e.g., be taken when calculating the downmix in a scene that is expected to contain correlated objects. It should be noted that strong correlation between sound sources can also result in the perception of phantom sound sources. This however also concerns the placement of the resulting cluster position and is therefore not discussed in the scope of signal downmixing.

In general, a low amount of correlation may randomly occur between originally independently created/recorded audio signals (when signals are not explicitly created to be orthogonal as e.g. independent random noise), though this is typically uncritical.

However, more substantial correlation between signals may, e.g., be introduced, depending on the production paradigms used for creating an object-based sound scene.

For example, in some cases objects are created from signals that originate from two or more channels of a stereo or multi-microphone recording within a sound scene. Another way to view this is that object-based audio scenes may contain “unmarked channel beds”, for example, recordings or productions that have originally been produced for loudspeaker playback, which have been re-used and put into object positions that roughly correspond to the intended loudspeaker positions. This would typically be known at the time of production, but may not be known to the clustering algorithm, depending on the metadata transport format. Similarly, but to a lesser extent, correlation may occur when objects are taken from multiple spot microphones within one physical scene, e.g. for different actors or instruments on a stage. This would typically not be considered to be a channel-based recording, but still crosstalk between the individual microphone signals can occur.

Furthermore, signal correlation can even occur for individually recorded or synthesized signals due to content relations, e.g. when multiple instruments follow the same melody line.

In some of these different cases, correlation between signals can be anticipated at production time and may be marked by appropriate metadata. However, when correlation is introduced more coincidentally, additional metadata is not available. Consequently, an object clustering algorithm cannot only rely on external information and needs to be able to detect and handled correlation appropriately when downmixing the object signals also without available metadata.

When there is correlation between object signals that are combined within one cluster signal, the signals' amplitudes rather than signals' energies may, e.g., be summed up, which can lead to a boost or loss in signal energy and thus differences in perceived loudness. According to some embodiments, in order to maintain the loudness perception of the original scene, a correlation-aware downmix may, e.g., be applied.

However, it is be acknowledged that the perceived effect of correlation between object signals also depends on the playback scenario and renderer algorithm that is used.

According to an embodiment, energy summation may, e.g., be conducted. In an idealized playback agnostic scenario, the objects represent physical sound sources in distinct spatial positions. Here the actual sound waves are physically superimposed in the reproduction environment and at the ears. Since typical listening environments are not anechoic (e.g. BS1116 room), especially for higher frequencies, the correlation between the signals arriving at the ears is reduced due different propagation paths (i.e. room reverberation as well as HRTF). As a simplified model, energy summation may, e.g., be assumed for this case. In an applied playback scenario, this may e.g. the case for binaural headphone reproduction, where different BRIRs (binaural room impulse responses) may, e.g., be applied for distinct sound source positions. For loudspeaker playback, this may, e.g., be assumed for cases where the distance between objects is large enough with respect to the loudspeaker placement so that objects are reproduced by distinct loudspeakers.

In an embodiment, amplitude summation may, e.g., be conducted. For amplitude panning based rendering (e.g. VBAP) on relatively sparse loudspeaker setups (e.g. typical home cinema setups), distinct source positions may, e.g., be panned and reproduced between the same pairs of loudspeakers. In this case, the signal amplitudes may, e.g., be added up in the rendering algorithm, resulting in a correlation dependent behavior of the energy sum.

A renderer agnostic object clustering algorithm would assume the idealized case of independent sound sources, and thus energy summation. However, the aim of an object clustering algorithm is often to be as close as possible to a reference rendering on a given rendering in given target playback scenario. This means the aim is to replicate the energy or amplitude summation characteristics of the target rendering and playback regarding the as well, regardless of whether the reference's behavior is deliberate.

Based on the targeted use-case, two downmix modes can be selected:

According to a first downmix mode, direct signal summation may, e.g., be conducted. If the object signals are assumed to be uncorrelated and/or if the target playback scenario is loudspeaker playback with amplitude panning, the object signals are just summed up into the cluster output signal. This mode is also avoids additional computational complexity for correlation analysis and therefore for real-time applications.

According to a second downmix mode, correlation aware signal summation may, e.g., be conducted. If the aim is energy preserving summation and correlation between signals is expected, an energy preservation weighting is applied.

In order to achieve preservation of the overall scene energy, an approach would be to calculate the energies of all objects before mixing, calculate the resulting energy of the downmixed signal, and to apply a gain correction factor to the downmixed signal. However, a pitfall of such a simple approach is that not all objects in a cluster are necessarily correlated in the same way. Therefore, such a global energy gain correction would also decrease the energy of the uncorrelated signals, and thus still result in an over-representation of the correlated signals in the final mix.

Hence, according to an embodiment, an advanced downmix algorithm based on the signal correlation may, e.g., be employed, for which a cross-correlation matrix between all objects in a cluster may, e.g., be calculated. Based on this, a downmix gain correction factor for each individual object may, e.g., be calculated. Thus, the overall energy relation between correlated and uncorrelated objects may, e.g., be preserved.

In detail, in a particular embodiment, the downmix coefficients may, e.g., be calculated, wherein the calculation may, e.g., comprise:

The cross-correlation matrix C between all member objects of a cluster may, e.g., be calculated as the dot-product from the signal samples. Additionally, the normalized correlation matrix C_norm may, e.g., calculated thereof, comprising the respective Pearson correlation coefficients. (Thus, the main diagonal of C corresponds to the signal energies, whereas the main diagonal of C_norm is all equal to 1).

For the purpose of an energy preserving downmix, only moderate to high correlations may, e.g., be of interest. Including low and negligible correlations due to random effects can even impede the stability and therefore perceived quality of the downmixing algorithm. Therefore, a threshold may, e.g., be applied to remove low correlation, by setting all entries in C to zero where the absolute value of C_norm is below 0.5.

Optionally, the correlation may, e.g., be limited to positive correlation only, thus only an increase in energy due to correlation is compensated, but no boost is applied in case of signal cancellations (e.g. in order to avoid clipping of the signals prior to downmixing in applications where there is no sufficient headroom).

For each object, an energy weight factor w_En may, e.g., be calculated as the ratio between the sum over the corresponding row in the correlation matrix and the signal energy.

$${w}_{E n} ( i ) = \frac{{\sum }_{j} c ( i , j )}{c ( i , i )}$$

In other words, this factor approximates by how much each object's energy is boosted due to correlation with other signals. If all signals have correlation below the threshold, there are only nonzero entries on the main diagonal, and all factors are one.

The respective weighting factors w_A for scaling the signal amplitude may, e.g., be calculated as the square root of the inverse energy weight:

$${w}_{A} ( i ) = ) \sqrt{\vert \frac{1}{{w}_{E n}} \vert}$$

The factors w_A are applied as scalar multipliers to the signals before addition in the time domain.

In typical implementations, the weighting factors w_A may, e.g., be limited, e.g., to a maximum value of 2, in order to prevent overly large boost factors in case of strong signal cancellation (or rather |w_En| may, e.g., correspondingly be limited in order to also prevent division by zero, e.g. to a minimum of 0.25). It should be noted that when signal cancellation occurs, large weighting factors would rather result in a boost of the remaining background noise than reconstruction of the cancelled signal components.

An enhancement to prevent signal cancellations is to detect strong negative correlation via an appropriate threshold (e.g. C(i,j)<−0.8), and to set the weighting factors of one of the negatively correlated signals to zero (e.g., to consider only one of the otherwise cancelled signals), or to apply negative weights. It should be noted that also for negative correlation in playback scenario for individual point sources in a non-anechoic environment, it can be assumed that signals would not entirely cancel out at the listener position due to decorrelation from room reverberation etc. In a sparse loudspeaker rendering, stronger signal cancellations may occur.

As a further enhancement, the correlation analysis and addition may, e.g., be applied in the frequency domain, for example, using an STFT (short-time Fourier transform) filter bank with appropriate band groupings.

In the following, a consideration of a distance based gain according to an embodiment is described.

Depending on the target use-case, a rendering algorithm can also consider a distance of the reproduced sound sources. A basic implementation is applying a distance-based gain to account for the radial distance between the listener and the sound source. If a target renderer is known to apply distance dependent gain, this may, e.g., be compensated when downmixing clusters, in order to prevent perceivable loudness differences in the reproduced scene.

If the actual distance gain function of the renderer is known to the clustering algorithm, the straightforward solution is to calculate the gain at the original source position and at the consolidated cluster position and to compensate the resulting gain difference prior to downmixing.

As a generalized, computationally efficient approach for clustering that is based on a PCS, the radial distance component from the PCS may, e.g., be utilized, which may, e.g., already be modeled after the distance dependent gain differences. Therefore, the difference in the radial distance component between the object and cluster positions may, e.g., directly be calculated and may, e.g., be applied as the gain difference, e.g., in dB.

In the following, further embodiments are described.

According to a first embodiment, clustering of object-based audio scenes based on perception-based models relative to a listener may, e.g., be conducted.

In a second embodiment, the Clustering algorithm of the first embodiment may, e.g., be based on a perceptual distance metric/perceptual distortion metric (PDM).

According to a first variant of the second embodiment, an identification and combination of clusters of objects within a given maximum PDM linkage may, e.g., be conducted, for example, all pairwise below just noticeable differences.

According to a second variant of the second embodiment, clustering by iterative agglomeration of closest objects in PDM may, e.g., be conducted, for example, until a target number of clusters is fulfilled, or for example, until a given maximum in the distortion metric is exceeded

In a third embodiment, the clustering algorithm of the first embodiment may, e.g., be based on a 3D-DLM similarity.

According to a first variant of the third embodiment, a recreation of original scene's 3D-DLM via fitting a Gaussian Mixture Model (GMM) may, e.g., be conducted.

According to a second variant of the third embodiment, an enhanced Expectation-Maximization (EM) algorithm for GMM fitting of weighted data points on an arbitrary grid may, e.g., be employed.

In a fourth embodiment, one or more enhancements for temporal stability in object-based clustering of the first to third embodiment may, e.g., be conducted.

According to a first variant of the fourth embodiment, a temporal smoothing and penalty factors in perceptual distance metrics may, e.g., be realized.

According to a second variant of the fourth embodiment, an optimization of cluster assignment permutations based on energy distribution may, e.g., be conducted.

According to a third variant of the fourth embodiment, a stabilization of resulting cluster centroid positions via hysteresis may, e.g., be conducted.

In a fifth embodiment, a perceptual optimization of centroid position resulting of clustering of one of the first to third embodiment may, e.g., be conducted.

According to a sixth embodiment, an optimization of a cluster assignment and centroid position based on spectral matching (‘EQ-Matching of HRTF’) for the clustering of the first embodiment may, e.g., be conducted.

In a seventh embodiment, signal processing for the combination of audio objects resulting from the clustering of the first embodiment may, e.g., be conducted.

According to a first variant of the seventh embodiment, crossfading to prevent signal discontinuities on object to cluster membership reassignments may, e.g., be conducted.

According to a second variant of the seventh embodiment, consideration of signal correlations to achieve energy preservation may, e.g., be conducted.

According to a third variant of the seventh embodiment, an adjustment of a distance-based gain may, e.g., be conducted.

According to a fourth variant of the seventh embodiment, equalization to compensate perceptual differences due to spectral cues may, e.g., be conducted.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus, comprising:
an input interface for receiving information on three or more audio objects, and
a cluster generator for generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster,
wherein the cluster generator is configured to generate the two or more audio object clusters depending on a perception-based model.

2. An apparatus according to claim 1,
wherein the cluster generator is configured to generate the two or more audio object clusters depending on a perception-based model by generating the two or more audio object clusters depending on at least one of a perceptual distance metric, a directional loudness map, a perceptual coordinate system, and a spatial masking model.

3. An apparatus according to claim 2,
wherein the cluster generator is configured to generate the two or more audio object clusters depending on the perceptual distance metric by determining for a pair of two audio objects of the three or more audio objects, whether said two audio objects comprise a perceptual distance according to the perceptual distance metric that is smaller than or equal to a threshold value, and by associating said two audio objects to a same one of the two or more audio object clusters, if said perceptual distance is smaller than or equal to said threshold value.

4. An apparatus according to claim 2,
wherein the cluster generator is configured to generate the two or more audio object clusters depending on the perceptual distance metric by iteratively associating two perceptually closest audio objects among the three or more audio objects according to the perceptual distance metric until a predefined target number of audio object clusters has been reached or until a predefined maximum perceptual distance according to the perceptual distance metric is exceeded.

5. An apparatus according to claim 1,
wherein the cluster generator is configured to generate the two or more audio object clusters depending on a three-dimensional directional loudness map.

6. An apparatus according to claim 5,
wherein the cluster generator is configured to generate the two or more audio object clusters by employing a Gaussian mixture model,
wherein the cluster generator is configured to determine two or more audio object clusters by determining components of the Gaussian mixture model such that the three-dimensional directional loudness map is approximated.

7. An apparatus according to claim 5,
wherein the cluster generator is configured to generate the two or more audio object clusters by employing a Gaussian mixture model,
wherein the cluster generator is configured to determine two or more audio object clusters by employing an expectation-maximization algorithm for fitting weighted data points on an arbitrary grid of the Gaussian mixture model.

8. An apparatus according to claim 1,
wherein the cluster generator is configured to conduct a perceptual optimization of a centroid position resulting from the clustering; and/or
wherein the cluster generator is configured to conduct an optimization of a cluster assignment and centroid position depending on a spectral matching for the two or more audio object clusters.

9. An apparatus according to claim 1,
wherein the cluster generator is configured to generate the two or more audio object clusters as a first plurality of audio object clusters by creating associations of each of the three or more audio objects with at least one of the two or more audio object clusters,
wherein the cluster generator is configured to generate a second plurality of two or more audio object clusters, such that at least one audio object of the three or more audio objects is associated with a different audio object cluster of the second plurality of audio object clusters compared to the audio object cluster of the first plurality of audio object clusters, with which said at least one audio objects was associated.

10. An apparatus according to claim 9,
wherein the cluster generator is configured to generate the second plurality of two or more audio object clusters depending on a temporal smoothing and/or depending on one or more penalty factors in the perceptual distance metrics.

11. An apparatus according to claim 9,
wherein the cluster generator is configured to generate the second plurality of two or more audio object clusters by conducting an optimization of cluster assignment permutations depending on an energy distribution of the three or more audio objects.

12. An apparatus according to claim 9,
wherein the cluster generator is configured to generate the second plurality of two or more audio object clusters by conducting a stabilization of resulting cluster centroid positions via hysteresis.

13. An apparatus according to claim 9,
wherein the cluster generator is configured to generate the second plurality of two or more audio object clusters by conducting a perceptual optimization of a centroid position resulting from the clustering to generate the first plurality of two or more audio object clusters; and/or
wherein the cluster generator is configured to generate the second plurality of two or more audio object clusters by conducting an optimization of a cluster assignment and centroid position depending on a spectral matching for the first plurality of audio object clusters.

14. An apparatus according to claim 1,
wherein cluster generator is configured, for each audio object cluster with which at least two of the three or more audio objects are associated, to conduct signal processing by combining the audio object signal of each audio object being associated with said audio object cluster.

15. An apparatus according to claim 14,
wherein the cluster generator is configured to conduct at least one of the following:
a crossfading to prevent signal discontinuities on object to cluster membership reassignments,
consideration of signal correlations to achieve energy preservation,
an adjustment of a distance-based gain,
equalization to compensate perceptual differences due to spectral cues.

16. An apparatus according to claim 1,
wherein the cluster generator is configured to generate the two or more audio object clusters depending on a real position or an assumed position of a listener.

17. An apparatus according to claim 1,
wherein the cluster generator is configured to determine one or more properties of each audio object cluster of the two or more audio object clusters depending on one or more properties of those of the three or more audio objects which are associated with said audio object cluster, wherein said one or more properties comprise at least one of:
an audio signal being associated with said audio object cluster,
a position being associated with said audio object cluster.

18. An apparatus according to claim 1,
wherein the apparatus further comprises an encoding unit for generating encoded information which encodes information on the two or more audio object clusters.

19. A system, comprising:
an apparatus according to claim 18, and
a decoding unit for decoding the encoded information to acquire the information on the two or more audio object clusters, and
a signal generator for generating two or more audio output signals depending on the information on the two or more audio object clusters.

20. A decoder, comprising:
a decoding unit for decoding encoded information to acquire information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model, and
a signal generator for generating two or more audio output signals depending on the information on the two or more audio object clusters.

21. A method, comprising:
receiving information on three or more audio objects, and
generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster,
wherein generating the two or more audio object clusters is conducted depending on a perception-based model.

22. A method, comprising:
decoding encoded information to acquire information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model, and
generating two or more audio output signals depending on the information on the two or more audio object clusters.

23. A non-transitory digital storage medium having a computer program stored thereon to perform the method comprising:
receiving information on three or more audio objects, and
generating two or more audio object clusters by associating each of the three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster,
wherein generating the two or more audio object clusters is conducted depending on a perception-based model,
when said computer program is run by a computer.

24. A non-transitory digital storage medium having a computer program stored thereon to perform the method comprising: decoding encoded information to acquire information on two or more audio object clusters, wherein the two or more audio object clusters have been generated by associating each of three or more audio objects with at least one of the two or more audio object clusters, such that, for each of the two or more audio object clusters, at least one of the three or more audio objects is associated to said audio object cluster, and such that, for each of at least one of the two or more audio object clusters, at least two of the three or more audio objects are associated with said audio object cluster, wherein the two or more audio object clusters have been generated depending on a perception-based model, and
generating two or more audio output signals depending on the information on the two or more audio object clusters,
when said computer program is run by a computer.
